(19) United States
(12) Patent Application Publication
(10) Pub. No.: US 2010/0306389 A1
(43) Pub. Date: Dec. 2, 2010

(54) RULE BASED MULTIMEDIA COMMUNICATION SYSTEM ON WEB PAGES

(76) Inventors: RUICAO MU, Richmond Hill (CA); Tie Hu, Scarborough (CA); Tingxue Huang, Toronto (CA)

Correspondence Address: TRAN & ASSOCIATES, P.O. Box 68, Saratoga, CA, 95071-0068, US

(21) Appl. No.: 12/473,267

(22) Filed: May 27, 2009

(51) Int. Cl. G06F 15/16

(52) U.S. Cl. 709/228

(57) ABSTRACT

A computer implemented process to support communication with a web site visitor includes rendering one or more web pages to be viewed by a web site visitor in a session; matching a customer service agent to the website visitor based on one or more predetermined rules and information from the session; and initiating multi-media communication requests to the web site visitor and the customer service agent based on a predetermined rules.

### FIELD OF THE INVENTION

This invention generally relates to method for providing live communications between web visitors and operators, more particularly, to a method for building a web-based communication system that initiate multimedia communications based on certain rule sets.

### BACKGROUND OF THE INVENTION

As the World Wide Web becomes the major channels for business to acquire new customers and serve existing customers, virtually all sellers have websites that cater to prospective customers. These web sites are carefully designed so that the targeted audience will visit the site and complete desired actions such as registering new accounts and/or making purchases.

A website usually provides a number of methods for its visitors to contact it, including its mailing address, telephone number, fax number, email, a form to submit online; some websites provide online forums for users to interact with each other, these forums can be moderated by the site operators, a visitor can have a chance to communicate with the site operators or their agents by posting and reading posts. Some websites provide official blogs, feeds, questions and answers written by their staff in efforts of keeping the communications as live as possible, as interactive as possible.

However, conventional communication methods are not live and on not directly on the web page. A visitor to a particular web page cannot receive instant help from an agent that is on the same page of the visitor. With conventional methods, the visitor has to start all over again explaining the questions s/he has on a particular page. This inconvenience can deter certain potential customers without a strong purchasing impulse from calling the company; and will frustrate some callers when they actually called. Regardless, in both cases conventional systems reduce the chance of customer acquisition and increase the communication cost when dealing with customers.

### SUMMARY

In one aspect, methods and systems are disclosed for a communication system that initiates communication sessions between a website visitor and an agent who work for the website based on predetermined rules.

In another aspect, methods and systems are disclosed for a communication system that automatically initiates a multimedia communication session between a web site visitor and an agent who work for the web site based on predetermined rules while the visitor is browsing the web site.

In yet another aspect, a computer implemented process to support communication with a web site visitor includes rendering one or more web pages to be viewed by a web site visitor in a session; matching a customer service agent to the website visitor based on one or more predetermined rules and information from the session; and initiating multi-media communication requests to the web site visitor and the customer service agent based on a predetermined rules.

In a further aspect, a computer system includes a server to render one or more web pages to be viewed by a web site visitor in a session; a rule engine matching a customer service agent to the website visitor based on one or more predetermined rules and information from the session; and a routing engine to initiate multi-media communication requests to the web site visitor and the customer service agent based on a predetermined rules.

In another aspect, a communication system includes a web server to render one or more web pages viewed by a web site visitor in a session; a rule engine accessing a client list and a customer service agent list, the rule engine matching a customer service agent to the website visitor based on one or more rules and information in the client list and customer service agent list; and a switch engine coupled to the rule engine to connect the matching customer service agent with the web site visitor while the visitor is browsing one of the web pages.

In yet another aspect, a computer implemented process to provide on-line customer service includes rendering a web site page to be browsed by a visitor; collecting information on visitor activities on the web site page; collecting browser parameters for the visitor; applying a rule set to the collected information and browser parameters to select a customer service agent to the visitor, and initiating multi-media communication request to link the visitor to the selected customer service agent based on the rule set while the visitor is browsing the web site page.

In another aspect, a communication system that initiates multi-media communication requests to both website visitors and website operators based on rule sets. A rule engine containing a plurality of rule sets can trigger the system to initiate communication requests to both parties automatically. Upon approval of the request, multi-media communication sessions including text messages, voice, video, and file images will be established between webpage visitors and website operators/agents. A routing engine is to route/peer the communication requests among visitors and available agents of the website.

Implementations of the above aspects can include one or more of the following. The session between a client and agent can be a multimedia session that contains instant text messages, voice calls, video conference, and file sharing. The session is embedded in a web page that the client is browsing, and the system can render the same web to the agent's computer with a session embedded in it. The rule engine is a database that stores parameters about a page visitor and his activities on page, collected from the web page and the client software embedded in the page. Typically the parameters are the client's IP address and location information contained in the IP address, such as city, state/province, country, time zone, network (DSL, Cable, Dialup among others), the client's time spent on a page, the browser cookie and the information reflected by the cookie, such as whether this is the first visit or repeat visit during a certain period (within a day, 12 hours, 8 hours, 4 hours, 1 hour among others), the page URL the visitor is on, among others. These parameters are detected and reported by both the client software and the web page being browsed, and sent back to the server software. Each rule in the rule engine is a combination of parameters representing a condition to trigger a communication requests to a client and an agent by the system. The rules can be, for a simplified but illustrative example, rule 1 being to trigger communication requests if a US visitor is on page URL 1 for over 2 minutes, and rule 2 being to trigger communication requests if a Canadian visitor is on page URL 3 for over 4 minutes, among others. New rules can be added to the engine and existing rules can be revised or deleted from the engine.

The client software can be embedded on each and every web page, that can be loaded into visitors' computers when they load the web pages. The client software will collect some data it detects from the user's computer and send the data to the server software. The server software of the communication system is coupled with database software with matrix of rule sets, e.g. the rule engine. When certain rules are triggered by the data collected by client software, the server will initiate two communication requests, one to the client software, and the other to an agent of the website who pre-install the software. Upon approval of the request by one party, a multi media communication session, including text, voice, video, file image, will be established between the visitor and agent. The rule engine is a database representing the rule sets. The rule sets define when a bi-directional communication request will be triggered. The rules can be any single or combination of parameters, such as the time span the client software being loaded, the time on web pages, the IP address, the geographic information the IP address represents, the page URL being loaded and other factors. The initiation of the communication request is neither by the visitor, nor by the agent manually. Instead, it is an automatic process triggered by the communication system. More specifically, it is triggered by the rule engine when certain rules are met. The rule engine is also coupled with a database maintaining a list of all agents, busy, and available. When the available agents reach zero or any pre-defined threshold number, the rule engine will notify the server software to stop initiating new communication requests.

Advantages of the preferred embodiment may include one or more of the following. The system provides live communications between a visitor and a customer service agent directly on the web page. The visitor to a particular web page can receive instant help from an agent that is on the same page of the visitor. The agent is “on the same page” with the visitor and provides helpful, convenient assistance on demand. This convenience can influence potential customers without a strong purchasing impulse to buy on the spot. As such, the system reduces the cost of customer acquisition and decreases communication costs. The system allows customer service agents to initiate the communication to assist customers if warranted. This capability enables web site to provide the high touch service that currently can only be provided by in-person department sales associates who can visually observe the customer behavior in the store. This ability to initiate communications with visitors increases the chance of making sales for site operators, and provides the site operators with intimate knowledge of visitors' interest in the site and its products. The system provides multimedia in communications capability with text, voice, and video communication as well as file sharing between both parties. The rule based engine provides a technical advantage to initiate communications based on real-time data rather than human guess or human estimate. It provides another advantage of the flexible combination of the rules at any time to meet the demands of various businesses, various goals, various priorities. The client software embedded in web pages provides another advantage of communicating with visitors in real time while they are browsing the pages, therefore increase the chance to make sales right at the time the visitors are interested. The multimedia communication provides improved user interface and richness of media, therefore enabling better and more convincing presentations of the products.

### BRIEF DESCRIPTION OF THE DRAWINGS

FIG. 1A is an exemplary system diagram illustrating a rule based, multimedia communication system for web pages.

FIG. 1B shows an exemplary process to optimally handle communications between a prospective customer and a customer representative.

FIG. 2 is an exemplary layout illustrating initiation of the communications from a visitor's perspective.

FIG. 3 is an exemplary layout of multimedia communication session with text, voice, and video.

FIG. 4 is an exemplary list of clients each of which contains various attributes.

FIG. 5 is an exemplary list of agents each of which contains various attributes.

FIG. 6 is an exemplary matrix of the rule engine.

FIG. 7 is an exemplary table of communication sessions administrated by session manager.

### DESCRIPTION

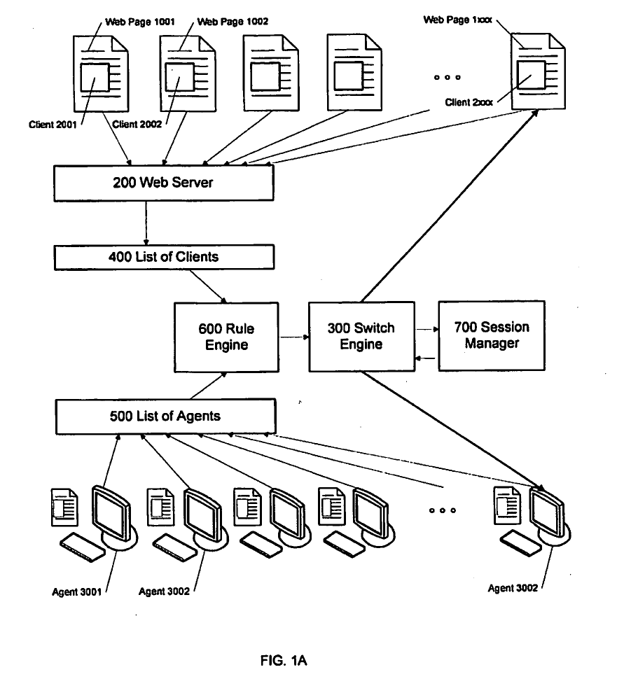

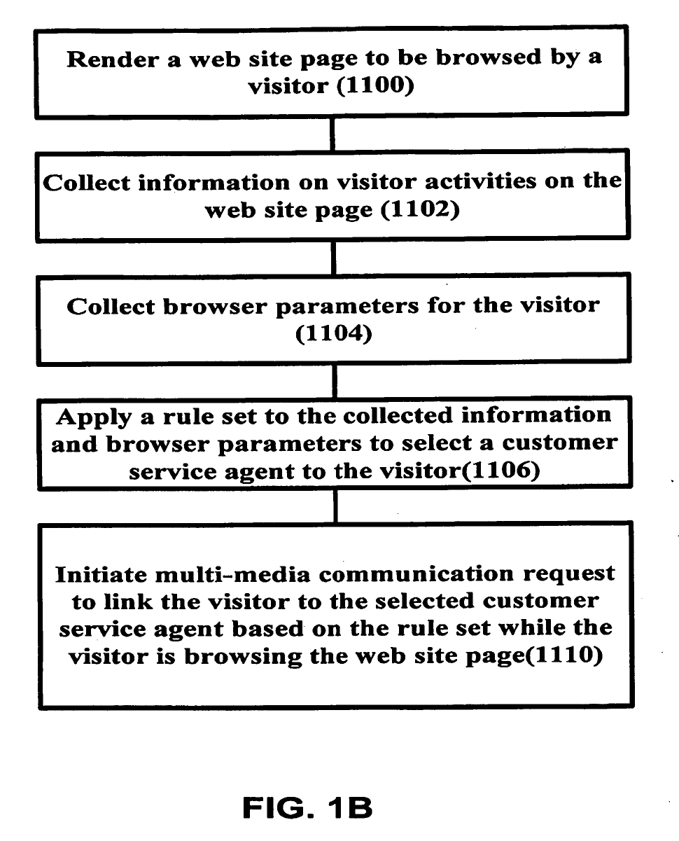

FIG. 1A is an exemplary diagram illustrating a preferred embodiment of the rule-based communication system on web pages. Web pages 1001, 1002 . . . 1xxx represent the web pages opened by website visitors to their computers when they browse the website. Client 2001, 2002 . . . 2xxx represent the client software the user needs to download to the user's computer to conduct multimedia communication sessions. In a preferred embodiment, each client software 2xxx is embedded into a web page 1xxx, in a form of ActiveX control component for an internet browser, or stand alone communication client software that is separated from an internet browser. In either case, when an internet user browser a web page 1001, s/he actually downloaded that page 1001 into her/his local computer, s/he can either download the client software 2001 as a component of the web page 1001 or download 2001 as a separate software, independent from internet browser. Nowadays there are a couple of browser components like Adobe Flash, Microsoft Silverlight among others that are already installed into the majority of internet users' browsers, technically they can be programmed as the client software for conducting multimedia communication sessions. The advantage is that they are already pre-installed, embedded in almost everybody's internet browser, there is no need for users to download separate client software before communicating.

In the preferred embodiment, the client software is embedded into each web page, a web server 200 is used to track which web page is being viewed by which visitor. Each such visitor will download a web page and embedded client software into its internet browser. When the browsing actions are taking place, web server 200 can collect the information such as:

Visitor IP Address 1, Page URL 1, Client Downloaded ID 1, Session Cookie 1, . . . .

Visitor IP Address 2, Page URL 1, Client Downloaded ID 2, Session Cookie 2, . . . .

Visitor IP Address 3, Page URL 2, Client Downloaded ID 3, Session Cookie 3, . . . .

In this embodiment web server 200 can provide web functions and services. The client software to communicate its information with web server in standard web protocol (http), but 200 can certainly be any none http-based server software that collaborates with the client software downloaded by site visitors to collect the information as illustrated above.

Block 400 is a list of clients, e.g. a database of unique site visitors with all kinds of parameters parsed from their IP address, browser cookies, among others. Each IP address collected by web server 200 contains information about the visitor, such as city, state, country, time zone, ISP, network speed (high speed or dial-up), among others. Each browser cookie can tell us if the visitor is a first timer or a repeat visitor. The information about a visitor will be parsed by 400, then based on the information a list of real-time onsite visitors will be established as such:

Visitor 1, IP 1, City 1, State 1, Country 1, Time on Page 1, High Speed, New . . . .

Visitor 2, IP 2, City 2, State 2, Country 2, Time on Page 2, Dial-up, Repeat . . . .

Visitor 3, IP 3, City 3, State 3, Country 3, Time on Page 3, High Speed, Repeat . . . .

Agent 3001, 3002 . . . 3xxx are the agents who work for the website either in a centralized location or in multiple locations, or home office respectively, in groups or in individuals. Each agent is equipped with a computer, loaded with client software specially designed for agent use. In one preferred embodiment, the agent software will load the same page URL as browsed by a visitor, so the agent can be on the same page as s/he speaks with the site visitor.

Block 500 is a list of agents, e.g. a database of agents with their status and availability. Each agent will periodically report its status to block 500, so block 500 maintains a real-time list of agent information such as:

Agent 1, Online, Available, Product Group 1, Location 1, DSL,

Agent 2, Online, Busy, Product Group 2, Location 2, Cable

Agent 3, Online, Away, Product Group 3, Location 3, Fibre

Agent 4, Online, Available, Product Group 4, Location 4, Fibre

Agent 5, Offline, NA, Product Group 5, Location 5, DSL

Block 600 is the rule engine. Rule engine is a database of selectively indexed parameters, one combination of which constitute one rule set. The rule set can be represented by a row of data strings with the rule number as primary key, as such:
Rule 1, city 1, state 1, country 1, time on page 1, network 1, new, product group 1, . . . .
Rule 2, city 2, state 2, country 2, time on page 2, network 2, repeat, product group 2, . . . .

Block 400 and block 500 feed data into the rule engine 600 with the respective client ID and agent ID, when these data match any row in rule engine 600, it is deemed that a rule set, or a condition set is met, therefore a communication request will be triggered to a client that meet the rule, simultaneously, another communication request will be triggered to an available agent that meets the same rule set.

The communication system of FIG. 1 initiates multi-media communication requests to both website visitors and website operators based on rule sets. The rule engine 600 contains a plurality of rule sets can trigger the system to initiate communication requests to both parties automatically. Upon approval of the request, multi-media communication sessions including text messages, voice, video, and file images will be established between webpage visitors and website operators/agents. The switch engine 300 then routes/peers the communication requests among visitors and available agents of the website.

In a simplified real world example, the rule set can be interpreted as such: if a New York visitor spend 3 minutes on a page about product A, the system will initiate request for communication to the visitor, and bridge him with an available agent who's an expert of product A; if the same page is visited by a Canadian visitor, the system will initiate request only after he spend 4 minutes on a page; again, if the same page is visited by an Indian visitor, the system will request for communication only if he is a repeat visitor among others.

The system adds intelligence in initiating communication requests to a site visitor based on various rules that can be customized to best serve the interest of both website operators and site visitors under different circumstances. Such intelligence is not possible with conventional communication systems. The rules can also be fine tuned and split tested, to enhance the user experience so that the user will receive the request right at the time he wants it.

Block 300 is the switch engine, which is a server software that initiates communication requests as instructed by the rule engine 600. The rule engine 600 feeds the switch engine 300 with the client ID and agent ID the requests need to be initiated to, and switch engine implements the instructions by initiating requests to both parties. Switch engine 300 works as a command center of all sessions. One major function of switch engine 300 is to establish the session, e.g. to manage the communication request and response until a session is established, another major function is to command and revise the session, e.g. to add new client or agent into an existing session; to change the image of a participant, or to add another agent to the session and delete the initial agent from it, among others. Another major function is to tear down the session upon certain conditions, or to delete a participant if a participant leaves a session or goes offline, among others.

Block 700 is a session management database. Relevant parameters of all sessions that have been initiated will be maintained in this database before they are terminated. The parameters include the session ID, the client ID (or client IDs in case multiple clients are invited into the same session), agent ID (or agent IDs in case multiple agents are invited into the same session), the status of the session (live, paused, among others), the time elapsed, the scheduled time to tear down the session among others. The session manager 700 maintains the list of live communications, instructs the switch server 300 to update the status of each participant, in case any dormant participant is found, it will instruct the switch server 300 to delete the dormant participant. In case all participants are dormant and not responding, the session ID will be labelled dormant, the session manager 700 will instruct switch server 300 to tear down the session.

Turning now to FIG. 1B, an exemplary process to provide communication between a visitor and a customer service directly on the web site is shown. The system provides a communication system which client software be embedded on each and every web page, that can be loaded into visitors computers when they load the web pages. The client software collects data it detects from the user's computer and sends the data to the server software.

Referring now to FIG. 1B, a computer implemented process to provide on-line customer service includes rendering a web site page to be browsed by a visitor (1100); collecting information on visitor activities on the web site page (1102); collecting browser parameters for the visitor (1104); applying a rule set to the collected information and browser parameters to select a customer service agent to the visitor (1106); and initiating multi-media communication request to link the visitor to the selected customer service agent based on the rule set while the visitor is browsing the web site page (1110).

The server software of the communication system is coupled with database software with matrix of rule sets, e.g. the rule engine. When certain rules are triggered by the data collected by client software, the server initiates two communication requests, one to the client software, and the other to an agent of the website running the pre-installed software. Upon approval of a request to communicate by one party, a multimedia communication session, including text, voice, video, file image, is established between the visitor and agent.

The communication system thus initiates communication sessions between a website visitor and an agent who work for the website based on certain rules. The session between a client and agent can be a multimedia session that contains instant text messages, voice calls, video conference, and file sharing. The session is embedded in a web page that the client is browsing, and the system can render the same web to the agent's computer with a session embedded in it. The rule engine is a database that stores parameters about a page visitor and his activities on page, collected from the web page and the client software embedded in the page. Typically the parameters are the client's IP address and location information contained in the IP address, such as city, state/province, country, time zone, network (DSL, Cable, Dialup among others), the client's time spent on a page, the browser cookie and the information reflected by the cookie, such as whether this is the first visit or repeat visit during a certain period (within a day, 12 hours, 8 hours, 4 hours, 1 hour among others), the page URL the visitor is on, among others. These parameters are detected and reported by both the client software and the web page being browsed, and sent back to the server software. Each rule in the rule engine is a combination of parameters representing a condition to trigger a communication requests to a client and an agent by the system. The rules can be, for a simplified but illustrative example, rule 1 being to trigger communication requests if a US visitor is on page URL 1 for over 2 minutes, and rule 2 being to trigger communication requests if a Canadian visitor is on page URL 3 for over 4 minutes, among others. New rules can be added to the engine and existing rules can be revised or deleted from the engine.

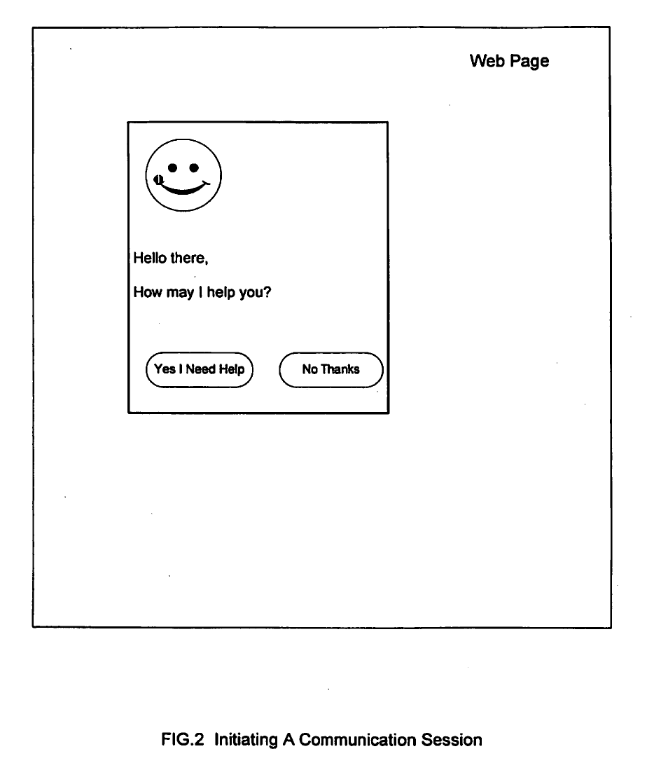

FIG. 2 is a page layout illustrating how a communication request is initiated to a visitor who is browsing a web page. In this preferred embodiment, the client software is made as a component of the internet browser, such as an ActiveX control ware, Adobe Flash, Microsoft Silverlight among others. that can be embedded into a web page. When a user browsing a page meets the conditions the rule engine pre-set, he will receive a little pop-up window within the web page asking something like “Hell there, how may I help you?” Within the next couple of minutes, the user can reply “Yes” to accept the request and start a session with a remote agent; or choose “No thank you” to show no intent to communicate at the moment. If the pop-up window isn't replied in certain time, the visitor is deemed to have no intent, so the pop-up window can disappear. A mechanism is designed to re-initiate a request for communication if certain activities are detected, for example, although the user reject the 1^{st} request, he's spending a long time on the page, in this event, the system may regard him as attempting to seek something and would offer help one more time politely. The position of the pop-up window can be in various location of the page as long as it grabs the due attention of the visitor.

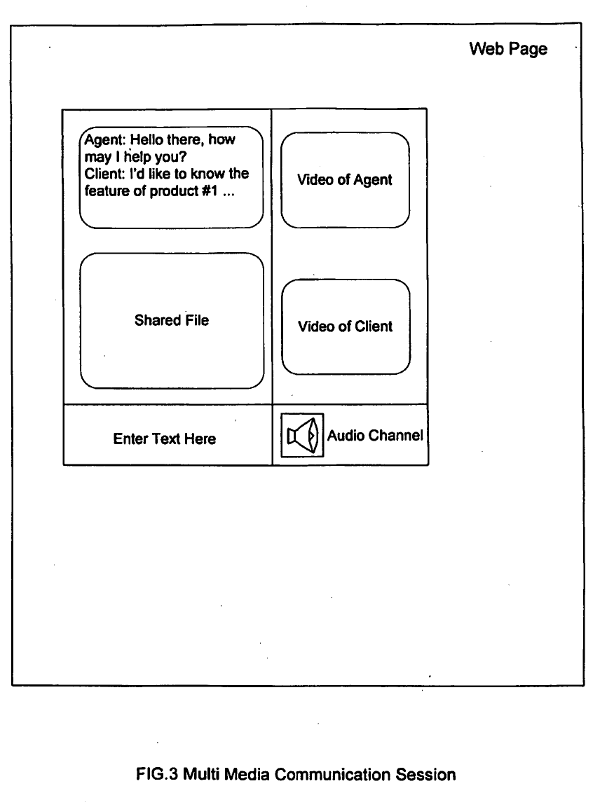

FIG. 3 is an exemplary layout illustrating the multimedia communication session between a visitor and an agent. In this embodiment, after the visitor accepts the communication request, the client software will expands itself to include text messaging, shared file, voice chat, and video conferencing capability for the visitor. The other client software on the agent side will enable the same multimedia capability for the agent. The multimedia session is established and controlled by the switch engine 300 illustrated in FIG. 2. In this preferred embodiment, the session is embedded in the web page the visitor is browsing, and the same web page will be prompted on agent's computer with the session embedded in it. This way, the agent is viewing the same page the client is viewing, and can exchange text message, conduct voice talk, share file, and have video conference with the client, either simultaneously or one after another. The multimedia session enables the agent to not only explain the product or service in text exchange, but also in voice and video exchange, and if necessary, even to demonstrate the product or service over shared file or video conference.

FIG. 3 is only an illustrative layout of a session with one agent and one visitor, in fact, multiple parties can join the same session. The agent can invite other agents and/or other visitors to have a group session. Same as the one to one session, group sessions will be switched and controlled by the switch engine, managed and maintained by the session manager.

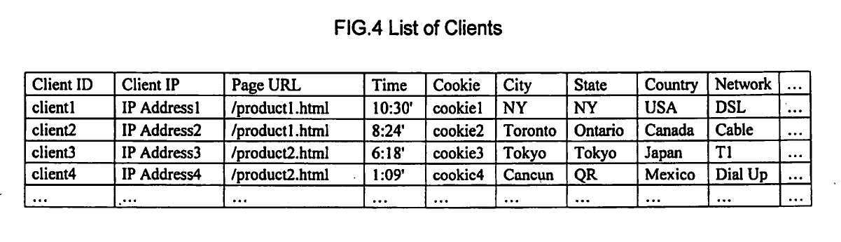

FIG. 4 is an exemplary list of clients illustrating how clients and their attributes are indexed. Each client software, when downloaded as a browser component to a user's computer, can detect and send data to the database of clients. These data represent information about a user and his activities on web page. FIG. 4 illustrates some of them, including IP address, the page URL, time elapsed on page, browser cookie or session cookie, the city, state, country of visit, access network (DSL, Cable, Fibre, Dial-up among others). In this preferred embodiment, a client ID is generated for each client software, the ID can be other unique attribute like its IP address or cookie, whose purpose is to let the rule engine, switch engine and session manager identify the client to which they should send communication request.

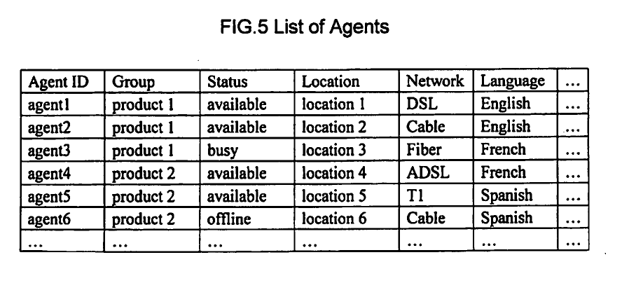

FIG. 5 is an exemplary list of agents. Each agent will report its ID, its status, the product group it belongs to, its location, its network speed, language spoken, and its availability to a database server such as illustrated in FIG. 5. The agents are people who work for the website in sales or customer support, they can register their information into the system and be grouped in different product categories, teams, locations, and languages among others. Once they log in the system, they will constantly update their status to the agents database. For example, an agent can be available 15 minutes ago but now become busy—because she is having a session with a site visitor; an agent can be in office 2 hours ago, but now she's at home but still available for work for the next hour among others. The agent database 500 maintains the information in real time, and will determine which agent to receive which communication request depending on the peering algorithm of parameters of both sides.

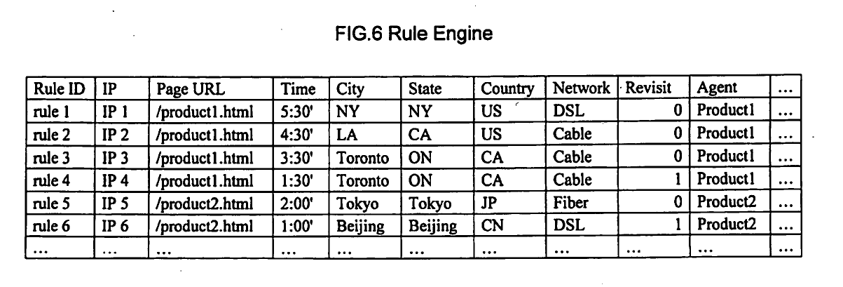

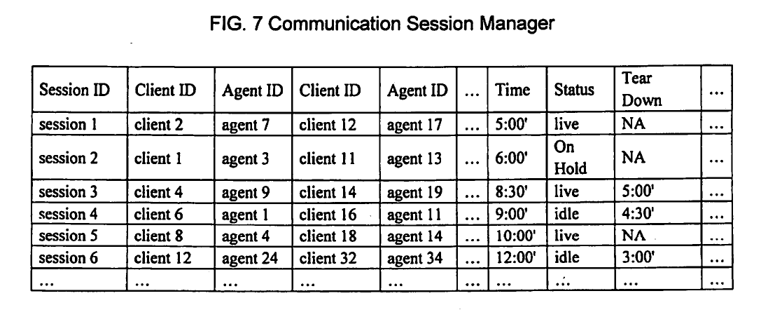

FIG. 6 is an exemplary layout of rule engine database. The rule engine is the major block of the preferred embodiment. The engine defines various rules based on which communication requests shall be initiated. Each rule is a set of parameters representing a visitor's identity and activities on a website. In the exemplary rules of FIG. 6, rule 1 represents exemplary logic that, if a visitor meets the following conditions: his location is New York City, he has a high speed internet access to internet, and he spends more than 5 minutes 30 seconds on the web page of product 1, then a communication request shall be initiated to this user, and to an agent that is specialized in product 1 (or belong to product 1 group). Rule 2 represents a logic that, if a user is from Los Angeles, Calif. with a high speed internet access (cable), and he's browsing the web page of product 1 for more than 4 minutes 30 seconds, a communication request shall be initiated to him and an agent specializing in product 1. Rule 3 represents the logic that, if a Toronto Canada visitor with a high speed internet access (cable) spends 3 minutes 30 seconds on the page of product 1, a communication request shall be initiated. Rule 4 represent the logic that, if a Toronto Canada repeat visitor with high speed internet access (cable) spends 1 minute 30 seconds on product 1 page, a communication request shall be initiated to him and an agent who specializes in product 1. Rule 5 represent the logic that, if a Tokyo Japan visitor with high speed internet access (fibre) spends 2 minutes on product 2 web page, a communication request shall be initiated to him and an agent working for product 2. Rule 6 represents the logic that, if a repeat visitor from Beijing China with high speed internet access (DSL) spends 1 minute on product 2, a communication request shall be initiated to him and an Agent working for product 2 who can speak Chinese, for example. The above rules are for illustrative purposes only and the present invention is not limited to the examples shown in FIG. 6-7.

The above description is only one simplified embodiment of the present invention, the rules can be and actually are expanded to many more parameters to fine tune the technical and business logics. The rules can be changed/optimized at any case to reflect the newly gained experiences and/observations of users on site. After reading the description, one of ordinary skills can figure out varieties, modifications, alterations, combinations, optimizations of rules to realize different technology and business logics. In addition, the page URL described above can be the page URL across different domains.

FIG. 7 is an exemplary layout of the database of communication session manager. The session manager collaborates with the switch engine 300 to maintain, modify, and control the sessions being established. After a session is established between an agent and a visitor, in many cases it needs to extend to other visitors or agents for a group session. Usually agent will initiate an invite to add other agents or visitors to join this group session, the agent can enter this invite to the session manager, the session manager will insert the newly invited agent ID or client ID into the session ID, and sends the new information to the switch engine 300. The switch engine 300 will then attempts to request the invited agents or clients to join the session. If the request is successful, it will signal session manager to include the agent ID and client ID in the table of participants of the group session. In the exemplary layout, for session 1, the participants are client 2, client 7, client 12, client 17 . . . among others.

If a participant leaves a session or be prompted to leave the session (such as an agent kicks out a visitor from the session), the session manager will receive the request from the participant or from the initiator, send the request to the switch engine 300 to remove one or more participants from the session. Once it is done, the switch engine 300 will update the session manager to remove the participants from the list too. This is a reverse process of adding participants into a session.

Another function of the session manager is to pause or suspend an ongoing session. In a one to one session between an agent and a visitor, the agent may need some time to collect information requested by the visitor, in this case the agent will instruct the session manager to put the visitor on hold, and the session manager instructs the switch engine to implement the instruction, and mark the status as on hold. In this on-hold period, the communication system can serve ads or product video clips to the client software for the user to view. When the agent returns to the session, the session manager will change the status back to “live”, ads will be stopped and live session will be resumed.

Time elapsed since the session is established is another parameter the session manager maintains in its records, as well as the status of the session. In this example, the status is maintained by collecting the periodical “alive” signal (as a data string) from the client software and the agent, so the session manager knows both parties are having a live session. If the periodical “alive” signal is missing for sometime, say for a few minutes and never re-transmitted, the session manager will consider the session to be idle (or dormant), in which case it will assign a time to automatically tear down the session. This mechanism ensures that all idle sessions are cleaned out, so the system is operating at high efficiency.

What is claimed is:

1. A computer implemented process to support communication with a web site visitor, comprising:
a. rendering one or more web pages to be viewed by a web site visitor in a session;
b. matching a customer service agent to the website visitor based on one or more predetermined rules and information from the session; and
c. initiating multi-media communication requests to the web site visitor and the customer service agent based on a predetermined rules.

2. The process of claim 1, wherein the session comprises a multimedia session with instant text messages, voice calls, video conference, and file sharing.

3. The process of claim 1, wherein the session is embedded in a web page that the web site visitor is browsing, and the server renders the same web page to the agent's computer with a session embedded therein.

4. The process of claim 1, comprising capturing parameters about the visitor and the visitor activities on the web page.

5. The process of claim 1, comprising collecting parameters from the web page and client software embedded in the web page.

6. The process of claim 1, comprising capturing visitor internet protocol (IP) address, location information contained in the IP address, time spent on a page, browser cookie information, and page universal resource locator (URL).

7. The process of claim 1, wherein each rule comprises a combination of parameters representing a condition to trigger a communication requests to a visitor and an agent by the system.

8. The process of claim 1, wherein each rule comprises a set of parameters representing a visitor's identity and activities on a website.

9. The process of claim 1, comprising managing the session and shutting down the session by monitoring a “keep alive” signal.

10. The process of claim 1, comprising extending the session established between the agent and the visitor to additional visitors or agents for a group session.

11. A computer system, comprising:
a. a server to render one or more web pages to be viewed by a web site visitor in a session;
b. a rule engine matching a customer service agent to the website visitor based on one or more predetermined rules and information from the session; and
c. a routing engine to initiate multi-media communication requests to the web site visitor and the customer service agent based on a predetermined rules.

12. The system of claim 11, wherein the session comprises a multimedia session with instant text messages, voice calls, video conference, and file sharing.

13. The system of claim 11, wherein the session is embedded in a web page that the web site visitor is browsing, and the server renders the same web page to the agent's computer with a session embedded therein.

14. The system of claim 11, comprising a client software downloaded to the visitor's computer to capture parameters about the visitor and the visitor activities on the web page.

15. The system of claim 16?, wherein the client software collects parameters from the web page and client software embedded in the web page.

16. The system of claim 16?, wherein the client software collects visitor internet protocol (IP) address, location information contained in the IP address, time spent on a page, browser cookie information, and page universal resource locator (URL).

17. The system of claim 1, wherein each rule comprises a combination of parameters representing a condition to trigger a communication request to a visitor and an agent by the system.

18. The system of claim 1, wherein each rule comprises a set of parameters representing a visitor's identity and activities on a website.

19. The system of claim 1, comprising a session manager coupled to the routing engine to manage the session and shutting down the session by monitoring a “keep alive” signal.

20. The system of claim 19, wherein the session manager extends the session established between the agent and the visitor to additional visitors or agents for a group session.
